(19) United States
(12) Patent Application Publication
(10) Pub. No.: US 2008/0270035 A1
(43) Pub. Date: Oct. 30, 2008

(54) System and Technique to Remove Perturbation Noise from Seismic Sensor Data

(76) Inventors: Ahmet Kemal Ozdemir, Asker (NO); Lars Borgen, Sande (NO)

Correspondence Address: WesternGeco L.L.C.;Jeffrey E. Griffin, 10001 Richmond Avenue, HOUSTON, TX, 77042-4299, US

(21) Appl. No.: 11/740,680

(22) Filed: Apr. 26, 2007

(51) Int. Cl. G01V 1/28

(52) U.S. Cl. 702/17; 114/244; 181/110

(57) ABSTRACT

A technique includes obtaining a noise measurement, which is acquired by a seismic sensor while in tow. Based on the noise measurement, a compensation for at least one of an alignment of the sensor and a calibration of the sensor is determined.

### BACKGROUND

The invention generally relates to a system and technique to remove perturbation noise from seismic sensor data.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes obtaining a noise measurement, which is acquired by a seismic sensor while in tow. Based on the noise measurement, a compensation for at least one of an alignment of the sensor and a calibration of the sensor sensitivity is determined.

In another embodiment of the invention, a technique includes obtaining a particle motion measurement acquired by a seismic sensor while in tow. The particle motion measurement is processed to remove perturbation noise based on a noise measurement acquired by the sensor while in tow.

In another embodiment of the invention, a system includes an interface to receive particle motion data acquired by a seismic sensor while in tow. A processor of the system processes the particle motion data to remove perturbation noise based on calibration factors derived from a noise record acquired by towing the sensor without activating a seismic source.

Advantages and other features of the invention will become apparent from the following drawing, description and claims.

### BRIEF DESCRIPTION OF THE DRAWING

FIG. 1 is a schematic diagram of a marine seismic data acquisition system according to an embodiment of the invention.

FIG. 2 is a flow diagram depicting a technique to estimate perturbation noise in a particle motion measurement and remove the perturbation noise from the particle motion data according to an embodiment of the invention.

FIG. 3 is an exemplary plot in frequency-wavenumber space of a cross-line component of vibration noise according to an embodiment of the invention.

FIG. 4 is an exemplary plot in frequency-wavenumber space of a vertical component of vibration noise according to an embodiment of the invention.

FIG. 5 is an exemplary plot in frequency-wavenumber space of a cross-line component of a seismic sensor measurement that was made in the absence of a seismic source and contains vibration noise and perturbation noise according to an embodiment of the invention.

FIG. 6 is an exemplary plot in frequency-wavenumber space of a vertical component of a seismic sensor measurement that contains vibration noise and perturbation noise according to an embodiment of the invention.

FIG. 7 depicts an exemplary plot in frequency-wavenumber space of an estimated cross-line component of the vibration noise in the seismic sensor measurement according to an embodiment of the invention.

FIG. 8 depicts an exemplary plot in frequency-wavenumber space of the estimated cross-line component of the perturbation noise in the seismic sensor measurement according to an embodiment of the invention.

FIG. 9 depicts an exemplary plot in frequency-wavenumber space of the estimated vertical component of the vibration noise in the seismic sensor measurement according to an embodiment of the invention.

FIG. 10 depicts an exemplary plot in frequency-wavenumber space of the estimated vertical component of the perturbation noise in the seismic sensor measurement according to an embodiment of the invention.

FIG. 11 is a flow diagram depicting a more detailed technique to estimate perturbation noise and remove the perturbation noise from a particle motion measurement according to an embodiment of the invention.

FIG. 12 depicts exemplary plots illustrating estimated and actual misalignment perturbations according to an embodiment of the invention.

FIG. 13 depicts exemplary plots illustrating an estimated cross-line component and an actual cross-line component of an amplitude perturbation according to an embodiment of the invention.

FIG. 14 depicts exemplary plots illustrating an estimated vertical component and an actual vertical component of an amplitude perturbation according to an embodiment of the invention.

FIG. 15 depicts an exemplary plot in frequency-wavenumber space of the cross-line component of a particle motion measurement after perturbation noise compensation according to an embodiment of the invention.

FIG. 16 depicts an exemplary plot in frequency-wavenumber space of the vertical component of a particle motion measurement after perturbation noise compensation according to an embodiment of the invention.

FIG. 17 depicts exemplary power spectral density plots of the cross-line component of the residual noise for the scenario when perturbation correction is used according to an embodiment of the invention and for the scenario when perturbation correction is not used.

FIG. 18 depicts exemplary power spectral density plots of the vertical component of the residual noise for the scenario when perturbation correction is used according to an embodiment of the invention and for the scenario when perturbation correction is not used.

FIG. 19 is a schematic diagram of a seismic data processing system according to an embodiment of the invention.

### DETAILED DESCRIPTION

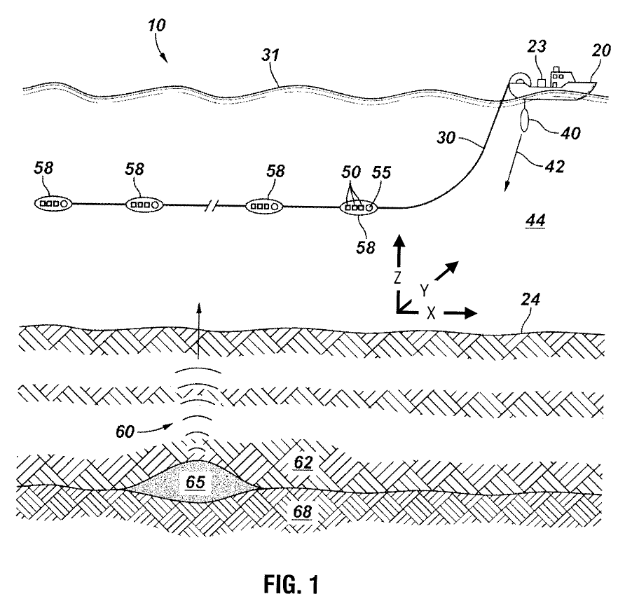

FIG. 1 depicts an embodiment 10 of a marine seismic data acquisition system in accordance with some embodiments of the invention. In the system 10, a survey vessel 20 tows one or more seismic streamers 30 (one exemplary streamer 30 being depicted in FIG. 1) behind the vessel 20. The seismic streamers 30 may be several thousand meters long and may contain various support cables (not shown), as well as wiring and/or circuitry (not shown) that may be used to support communication along the streamers 30.

Each seismic streamer 30 contains seismic sensors, which record seismic signals. In accordance with some embodiments of the invention, the seismic sensors are multi-component seismic sensors 58, each of which is capable of detecting a pressure wave field and at least one component of a particle motion that is associated with acoustic signals that are proximate to the multi-component seismic sensor 58. Examples of particle motions include one or more components of a particle displacement, one or more components (inline (x), crossline (y) and vertical (z) components, for example) of a particle velocity and one or more components of a particle acceleration.

Depending on the particular embodiment of the invention, the multi-component seismic sensor 58 may include one or more hydrophones, geophones, particle displacement sensors, particle velocity sensors, accelerometers, or combinations thereof.

For example, in accordance with some embodiments of the invention, a particular multi-component seismic sensor 58 may include a hydrophone 55 for measuring pressure and three orthogonally-aligned accelerometers 50 to measure three corresponding orthogonal components of particle velocity and/or acceleration near the seismic sensor 58. It is noted that the multi-component seismic sensor 58 may be implemented as a single device (as depicted in FIG. 1) or may be implemented as a plurality of devices, depending on the particular embodiment of the invention.

The marine seismic data acquisition system 10 includes one or more seismic sources 40 (one exemplary source 40 being depicted in FIG. 1), such as air guns and the like. In some embodiments of the invention, the seismic sources 40 may be coupled to, or towed by, the survey vessel 20. Alternatively, in other embodiments of the invention, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the multi-component seismic sensors 58. It is noted that the pressure waves that are received and sensed by the multi-component seismic sensors 58 include “up going” pressure waves that propagate to the sensors 58 without reflection, as well as “down going” pressure waves that are produced by reflections of the pressure waves 60 from an air-water boundary 31.

The multi-component seismic sensors 58 generate signals (digital signals, for example), called “traces,” which indicate the detected pressure waves. The traces are recorded and may be at least partially processed by a signal processing unit 23 that is deployed on the survey vessel 20, in accordance with some embodiments of the invention. For example, a particular multi-component seismic sensor 58 may provide a trace, which corresponds to a measure of a pressure wave field by its hydrophone 55; and the sensor 58 may provide one or more traces that correspond to one or more components of particle motion, which are measured by its accelerometers 50.

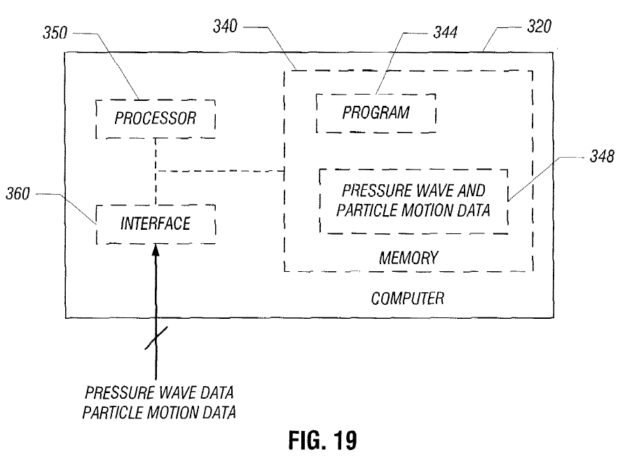

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system (such as an exemplary seismic data processing system 320 that is depicted in FIG. 19 and is further described below) that may be, for example, located on land or on the vessel 20. Thus, many variations are possible and are within the scope of the appended claims.

The down going pressure waves create an interference known as “ghost” in the art. Depending on the incidence angle of the up going wave field and the depth of the streamer cable, the interference between the up going and down going wave fields creates nulls, or notches, in the recorded spectrum. These notches may reduce the useful bandwidth of the spectrum and may limit the possibility of towing the streamers 30 in relatively deep water (water greater than 20 meters (m), for example).

The technique of decomposing the recorded wave field into up and down going components is often referred to as wave field separation, or “deghosting.” The particle motion data that is provided by the multi-component seismic sensor 58 allows the recovery of “ghost” free data, which means the data that is indicative of the up going wave field.

The particle motion data contains the desired signal, along with vibration noise. Because the vibration noise and the seismic signal have different apparent velocities of propagation, this difference allows the vibration noise to be disseminated from the seismic recordings for a large portion of the frequency band of interest. The efficiency of the noise removal process typically is very high for particle motion sensors that are perfectly calibrated (i.e., the sensors have the same sensitivity) and perfectly aligned (i.e., the sensors have the same alignment with respect to the streamer axis). However, perturbations in the calibration and/or alignment give rise to perturbation errors, or perturbation noise, which may adversely affect the noise removal performance. Perturbation noise may be caused by sensitivity differences between the particle motion sensors, misalignments between the sensors' axes and the streamer's axis, variations in the sensor spacing, etc.

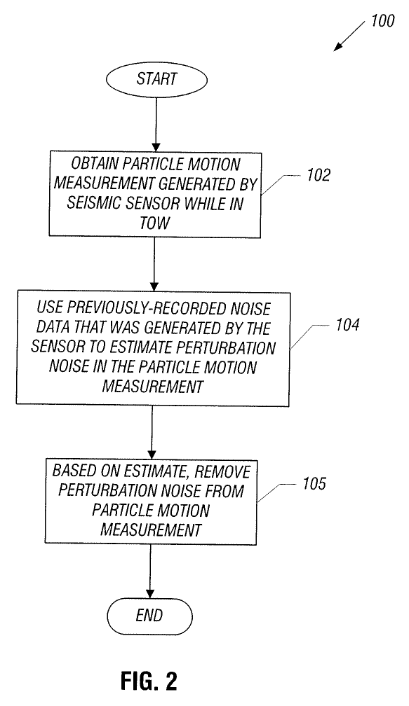

Referring to FIG. 2, in accordance with embodiments of the invention, a technique 100 may be used to substantially remove perturbation noise from a particle motion measurement. The technique 100 includes obtaining (block 102) a particle motion measurement, which is acquired by a seismic sensor while in tow. The particle motion measurement may contain perturbation noise due to sensor calibration and alignment imperfections (as examples). However, as described herein, previously-recorded noise data that was acquired by the sensor is used (block 104) to estimate the perturbation noise and remove (block 105) the perturbation noise from the particle motion measurement.

More specifically, a noise record for the particle motion sensor is obtained by towing the sensor in the absence of a seismic signal source (i.e., towing the sensor in the absence of any seismic shots or reflections). The noise record therefore primarily includes vibration noise and perturbation noise and does not include any seismic signal content. Because the vibration noise is coherent in time and space, the vibration noise may be effectively separated in frequency and wavenumber. Due to the separation of the vibration noise, a calibration algorithm may be applied, as described herein, to derive perturbation calibration factors, which characterize the perturbation noise for the sensor.

Thus, based on the noise that is recorded in the absence of a seismic source, perturbation noise calibration factors may be derived for all of the particle motion sensors; and these calibration factors may be used to estimate and remove perturbation noise from particle motion measurements that are acquired by the sensors while being towed with one or more active seismic sources. The removal of the perturbation noise from the particle motion measurements may occur before the particle motion measurements are filtered to remove vibration noise. The calibration factors may be kept constant within a time period in which seismic signals are recorded but may otherwise be updated as desired.

The derivation of the perturbation calibration factors from the noise record is now described in more detail. For purposes of simplifying the description herein, it is assumed that the perturbation noise pertains to amplitude and alignment perturbations for the cross-line (i.e., pertaining to the y axis of FIG. 1)) and vertical (z axis) components of the particle velocity. Otherwise, the proposed invention can be used to remove the perturbations on all of the 3 components (x axis, y axis and z axis) of the particle velocity measurements. The cross-line and vertical components of the actual vibration noise that should be recorded by a perfectly-calibrated array of sensors are herein referred to as “n_{y} (t, x)” and “n_{z} (t, x),” respectively. In this notation, “x” represents the in-line position (i.e., the position along the x axis of FIG. 1) of the sensors. It is assumed in the following discussion that the n_{y} (t, x) and n_{z} (t, x) noise components are statistically independent.

In the presence of perturbation noise, the noise that is recorded by the particle motion sensors (in the absence of an active seismic source) may be described as follows:

$$[ \begin{matrix}{n}_{yr} ( f , x ) \\ {n}_{zr} ( f , x )\end{matrix} ] = [ \begin{matrix}cos θ ( f , x ) & sin θ ( f , x ) \\ - sin θ ( f , x ) & cos θ ( f , x )\end{matrix} ] \\ [ \begin{matrix}1 + α ( f , x ) & 0 \\ 0 & 1 + β ( f , x )\end{matrix} ] [ \begin{matrix}{n}_{y} ( f , x ) \\ {n}_{z} ( f , x )\end{matrix} ] , \qquad Eq . 1$$

where “n_{yr}(f, x)” represents the cross-line component of the recorded noise in the f-x domain; “n_{zr} (f, x)” represents the vertical component of the recorded noise in the f-x domain; “θ(f,x),” one of the calibration factors, represents the frequency dependent misalignment perturbation in radians; and “α(f,x)” and “β(f,x),” the other calibration factors, represent the frequency dependent amplitude perturbations around a nominal value of one. Although the perturbations in this model have been defined as being frequency dependent, it is noted that the perturbations may be frequency independent, in accordance with other embodiments of the invention. Thus, many variations are contemplated and are within the scope of the appended claims.

Assuming that the perturbation noise is relatively small as compared to nominal values, the recorded noise may be approximated as follows:

$$[ \begin{matrix}{n}_{yr} ( f , x ) \\ {n}_{zr} ( f , x )\end{matrix} ] ≅ [ \begin{matrix}1 + α ( f , x ) & θ ( f , x ) \\ - θ ( f , x ) & 1 + β ( f , x )\end{matrix} ] [ \begin{matrix}{n}_{y} ( f , x ) \\ {n}_{z} ( f , x )\end{matrix} ] , \qquad Eq . 2$$

In terms of perturbation noises called “p_{y}(f, x),” which represents the cross-line component of the perturbation noise and “p_{z}(f, x),” which represents the vertical component of the perturbation noise, the recorded noise may be described as follows:

n_{yr}(f,x)=n_{y}(f,x)+p_{y}(f,x), and Eq. 3

n_{zr}(f,x)=n_{z}(f,x)+p_{z}(f,x). Eq. 4

For this representation, the p_{y}(f, x) and p_{z}(f, x) perturbation noise may be described as follows:

p_{y}(f,x)=α(f,x)n_{y}(f,x)+θ(f,x)n_{z}(f,x), and Eq. 5

p_{z}(f,x)=β(f,x)n_{z}(f,x)+θ(f,x)n_{y}(f,x). Eq. 6

Based on theory and experimental results, it has been discovered (especially for solid and gel-filled streamers) that the vibration noise is highly localized around a frequency-wavenumber dispersion relation, which is set forth below:

$$f ( k ) = v ( k ) k = \frac{\sqrt{{π}^{3} {d}^{4} {Ek}^{2} + 16 T}}{\sqrt{4 π {d}^{2} ρ}} k , \qquad Eq . 7$$

where “k” represents the wave number (1/meter (m)); ‘f’ represents the frequency in Hertz (Hz); “T” represents the tension in Neutons (N); “d” represents the diameter of the streamer cable in meters; “E” represents Young's modulus in Pascals (Pa); and “ρ” represents the density of sea water in kilograms (kg)/m³; and “v” represents the propagation speed of the vibration noise. As described below, the relationship that is set forth in Eq. 7 is used to extract the perturbation noise and thus, derive the perturbation noise calibration factors. It should be noted that if the vibration noise does not satisfy the dispersion relation given by Eq. 7, this does not constitute a limitation to the current invention. If the vibration noise has a different frequency-wavenumber relationship for a given acquisition system, the corresponding relationship can be estimated by analysis of the FK spectrum of the recorded vibration noise.

More particularly, the vibration noise record is separated into vibration noise and perturbation noise components using a filter called “H (f, k).” The H (f, k) filter is a frequency-wavenumber f-k) filter in a narrow wavenumber and frequency band centered at (k, f(k)) for each wavenumber k. Because along the (f,k) dispersion relation (Eq. 7) the vibration noise is significantly stronger than the perturbation noise, the following relationships may be defined:

n_{y}(f,k)≅H(f,k)n_{yr}(f,k), Eq. 8

n_{z}(f,k)≅H(f,k)n_{zr}(f,k), Eq. 9

p_{y}(f,k)≅(1−H(f,k))n_{yr}(f,k), and Eq. 10

p_{z}(f,k)≅(1−H(f,k))n_{zr}(f,k) Eq. 11

where the f-k domain variables are computed by applying Fourier transformation to the f-x domain variables along the space dimension (x).

Because the cross-line (y) and vertical (z) vibration noise components are statistically independent, the α(f,x), β(f,x) and θ(f,x) calibration factors may be estimated by using the projection theorem as follows:

$$\begin{matrix}α ( f , x ) = \frac{〈 {p}_{y} ( f , x ) , {n}_{y} ( f , x ) 〉}{ 〈 {n}_{y} ( f , x ) , {n}_{y} ( f , x ) 〉} , & Eq . 12 \\ β ( f , x ) = \frac{〈 {p}_{z} ( f , x ) , {n}_{z} ( f , x ) 〉}{〈 {n}_{z} ( f , x ) , {n}_{z} ( f , x ) 〉} , and & Eq . 13 \\ θ ( f , x ) = \frac{1}{2} \frac{〈 {p}_{y} ( f , x ) , {n}_{z} ( f , x ) 〉}{ 〈 {n}_{z} ( f , x ) , {n}_{z} ( f , x ) 〉} - \frac{1}{2} \frac{〈 {p}_{z} ( f , x ) , {n}_{y} ( f , x ) 〉}{〈 {n}_{y} ( f , x ) , {n}_{y} ( f , x ) 〉} , & Eq . 14\end{matrix}$$

where “ [symbol] ” represents the statistical expectation operator. Note that in applications, where a single realization of the noise measurement is available, the statistical averages can be approximated as by using the measured noise realization. To given as an example, [symbol] p_{y}(f,x),n_{y}(f,x)) [symbol] p_{y}(f,x)n*_{y}(f,x), where “*” denotes complex conjugation. Furthermore, if the calibration factors are frequency independent, the statistical average can be approximated by frequency averages. To give as an example, [symbol] p_{y}(x), n_{y}(x)) [symbol] ∫w(f)p_{y}(f,x)n*_{y}(f,x)df, where w(f) is a smoothing function to mitigate the edge effects during integration.

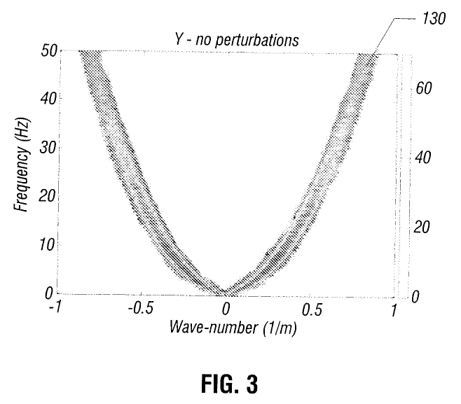

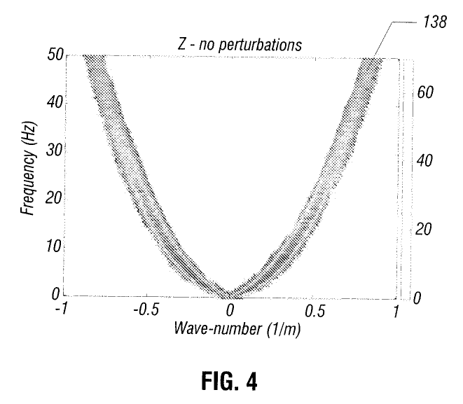

For purposes of illustrating the perturbation noise compensation techniques that are disclosed herein, FIGS. 3 and 4 depict frequency-wavenumber (f-k) plots of synthetically-acquired vibration noise. The plots do not contain any perturbation noise or seismic signal content. In particular, FIG. 3 depicts an f-k plot that depicts the cross-line component 130 of the vibration noise; and FIG. 4 depicts an f-k plot that depicts the vertical component 138 of the vibration noise. The spatial sampling interval chosen for the simulation is 50 centimeters (cm). As can be seen from FIGS. 3 and 4, the vibration noise is highly localized around the frequency-wavenumber dispersion relation that is set forth in Equation 7.

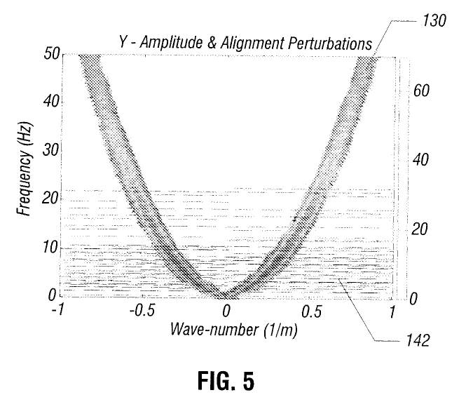

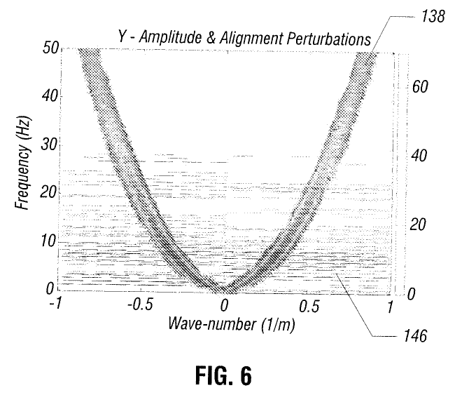

For purposes of example, if amplitude and rotation angle perturbations with standard deviations of 0.02 (around the nominal value) and one degree, respectively, are introduced to the vibration noise that is depicted in FIGS. 3 and 4, the coherent energy of the vibration noise is dispersed in the f-k plane, as depicted in FIGS. 5 and 6. In this regard, FIG. 5 depicts a plot in f-k space, which contains the cross-line component 130 of the vibration noise in addition to perturbation noise 142; and similarly, FIG. 6 depicts the vertical component 138 of the vibration noise in addition to perturbation noise 146.

Although not depicted in FIGS. 5 and 6, the seismic signal content, if present, would be localized around k=0; and thus, the vibration noise components 130 and 138 would not overlap with the signal except for very low frequencies. However, as depicted in FIGS. 5 and 6, the perturbation noise 142 and 146 overlaps with the signal at almost all frequencies, thereby making the perturbation noise difficult if not possible to remove without the techniques that are disclosed herein.

Because the perturbation noise calibration factors are frequency independent in this example (in accordance with some embodiments of the invention), the calibration factors may be derived from any frequency where relatively low acoustic noise levels are expected. As an example, the H (f, k) filter may be selected to have a pass band of 19-20 Hz in frequency and 0.39-0.53 1/m in wavenumber. The application of the H(f, k) filter on the recorded noise yields estimates of the n_{y}(, x) and n_{z}(f,x) noise, pursuant to Equations 8 and 9. Pursuant to Equations 10 and 11, the application of a filter described by 1−H(f,k) produces estimates of the respective components p_{y}(f,x) and p_{z}(f,x) of the perturbation noise.

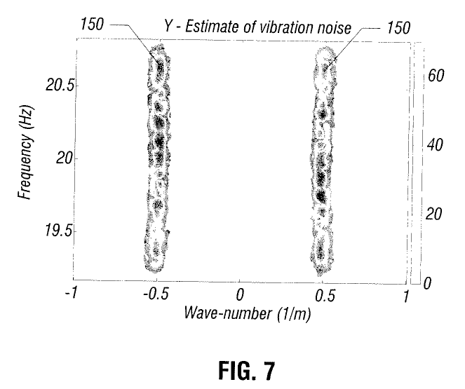

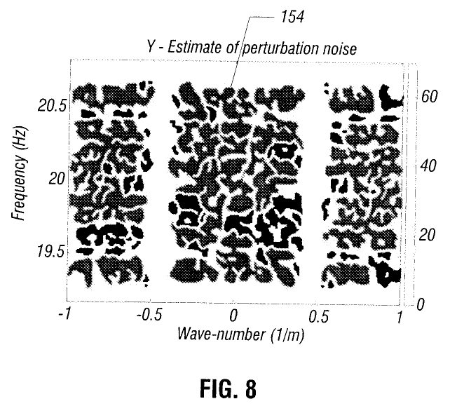

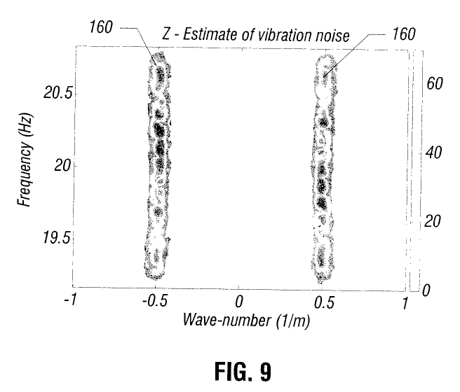

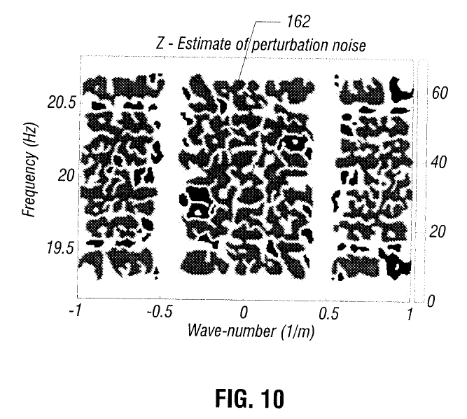

As a more specific example, FIGS. 7 and 9 depict the application of the H(f, k) filter to produce an estimate 150 (FIG. 7) of the cross-line component of the vibration noise and produce an estimate 160 (FIG. 9) of the vertical component of the vibration noise. Applying the 1−H(f, k) filter produces an estimates of the perturbation noise, as depicted in FIGS. 8 and 10. More specifically, applying the 1−H(f, k) filter to the cross-line component of the vibration noise produces an estimate 54 (FIG. 8) of the cross-line component of the perturbation noise; and applying the 1−H(f, k) filter to the vertical component of the vibration noise produces an estimate 162 (FIG. 10) of the vertical component of the perturbation noise.

Equations 12, 13 and 14 may be applied, based on the estimated vibration and perturbation noise, to derive the α(f,x), β(f,x) and θ(f,x) perturbation noise calibration factors. Perturbation noise may therefore be removed from particle motion measurements based on these factors.

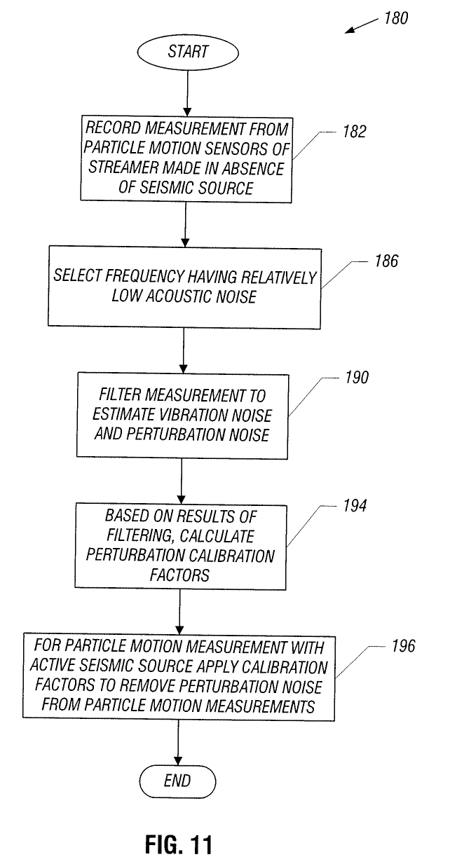

To summarize, FIG. 11 depicts a technique 180 that may be used to remove perturbation errors, or perturbation noise, in accordance with some embodiments of the invention. Pursuant to the technique 180, a measurement that is acquired by a particle motion sensor the absence of a seismic signal source is obtained (block 182). A frequency that has a relatively low acoustic noise is selected (block 186). In a narrow frequency and wavenumber band centered at the selected frequency, the measurement is filtered to estimate the vibration noise and perturbation noise components in the measurement pursuant to block 190. Based on the results of the filtering, the calibration factors may be calculated pursuant to block 194. For particle motion measurements that are subsequently acquired by an active seismic source, the calibration factors may be applied to these measurements to remove perturbation noise before the measurements are processed to remove vibration noise, pursuant to block 196.

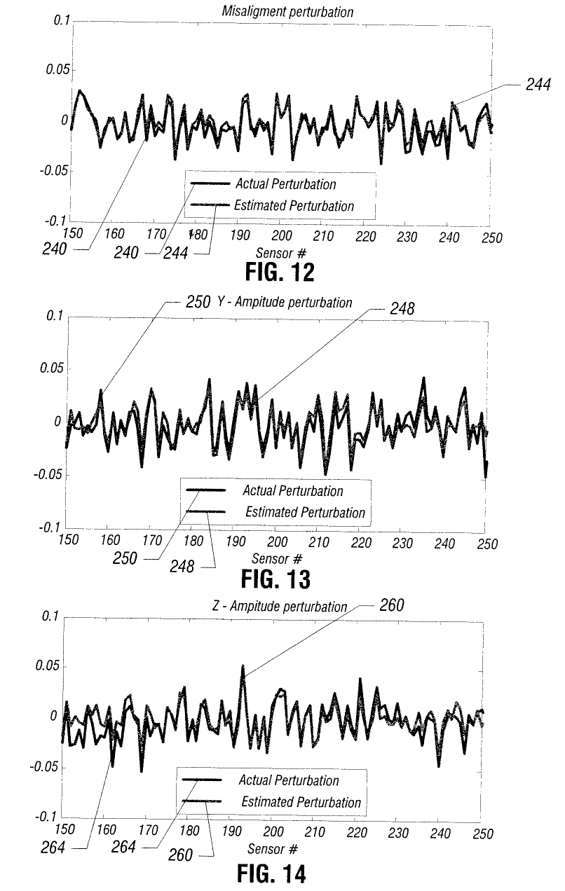

FIG. 12 depicts an actual misalignment perturbation curve 240 for the sensors of the streamer and an estimated misalignment perturbation curve 244, which was calculated using the techniques that are disclosed herein. As shown, the estimated perturbation curve 244 closely follows the actual curve 240. For the cross-line component of the amplitude perturbation, FIG. 13 depicts an estimated perturbation curve 248, which closely follows an actual perturbation curve 250. Similarly, for the vertical component of the amplitude perturbation, FIG. 14 depicts an estimated perturbation curve 260, which closely follows an actual perturbation curve 264.

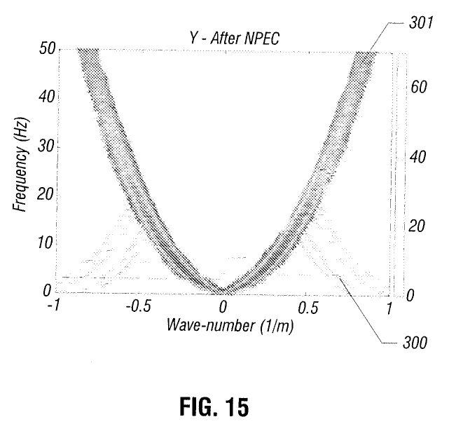

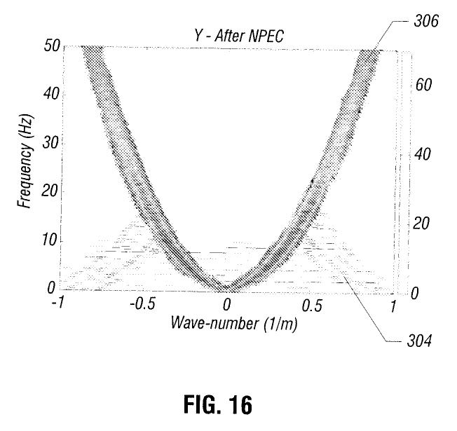

FIG. 15 depicts an f-k plot of the cross-line component of the recorded noise after perturbation noise correction. After perturbation noise correction, significantly diminished noise 300 exists outside of an envelope 301 (see Eq. 7) that contains the cross-line component of the vibration noise. Similarly, referring to FIG. 16, which depicts the vertical component of the recorded noise, after perturbation noise correction, significantly diminished noise 304 exists outside of an envelope 306 that contains the vertical component of the vibration noise.

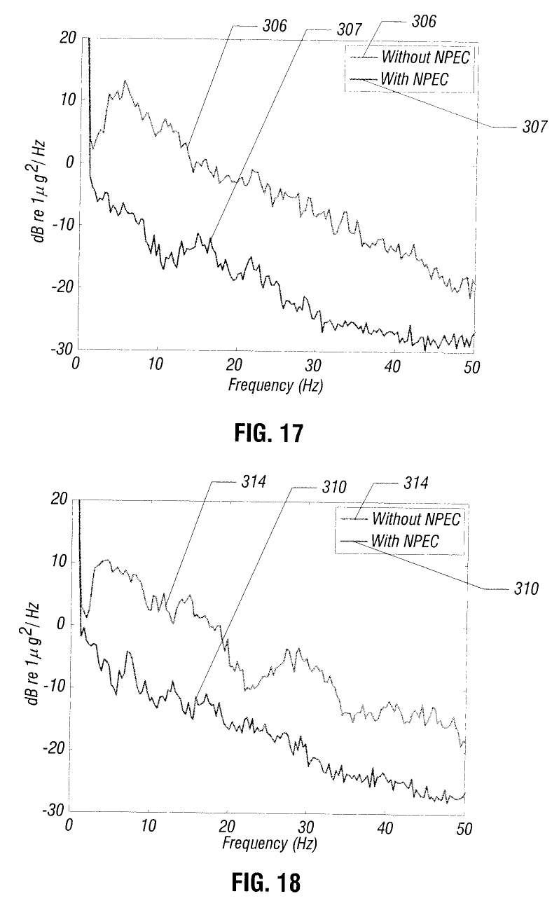

FIGS. 17 and 18 depict power spectral densities of residual noises with and without perturbation correction. More specifically, FIG. 17 depicts a power spectral density curve 306 for the cross-line component of the residual noise without perturbation correction, which is significantly higher than a power spectral density curve 307 in which perturbation correction is used. As depicted in FIG. 18, for the vertical component of the residual noise, a power spectral density curve 310 for the vertical component of the residual noise when perturbation correction is not used is significantly higher than a power spectral density curve 314 when perturbation correction is used.

Referring to FIG. 19, in accordance with some embodiments of the invention, a seismic data processing system 320 may perform the techniques 100 (FIG. 2) and 180 (FIG. 11) and variations therefore for purposes of estimating the perturbation noise calibration factors and removing perturbation noise from a particle motion measurements. In accordance with some embodiments of the invention, the system 320 may include a processor 350, such as one or more microprocessors and/or microcontrollers. The processor 350 may be located on the streamer 30 (FIG. 1), located on the vessel 20, located at a land-based processing facility, etc., depending on the particular embodiment of the invention. The processor 350 may be coupled to a communication interface 360 for purposes of receiving seismic data that corresponds to pressure and particle motion measurements. Thus, in accordance with embodiments of the invention described herein, the processor 350, when executing instructions stored in a memory of the seismic data processing system 320, may receive particle motion data that is acquired by a seismic sensor while in tow. It is noted that, depending on the particular embodiment of the invention, the particle motion data may be data that is directly received from the seismic sensor as the data is being acquired (for the case in which the processor 350 is part of the survey system, such as part of the vessel or streamer) or may be particle motion data that was previously acquired by the seismic sensor while in tow and stored and communicated to the processor 350, which may be in a land-based facility, for example. The processor 350 processes the particle motion data to remove perturbation noise based on previously-recorded noise data that was acquired by the seismic sensor while in tow, pursuant to the techniques that are disclosed herein.

As examples, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the seismic data processing system 320 and may store, for example, various data sets involved with the techniques 10 and 100, as indicated by reference numeral 348. These data sets may include one or more of the following (as non-limiting examples), depending on the state of the seismic data processing: raw particle motion data; particle motion data that has been processed to remove perturbation noise; particle motion data that has been processed to remove perturbation noise; vibration noise data recorded without an active seismic signal source; vibration noise estimates; perturbation noise estimates; and perturbation noise calibration factors. The memory 340 may store program instructions 344, which when executed by the processor 350, may cause the processor 350 to perform one or more of the techniques that are disclosed herein, such as the techniques 10 and 100, for example.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
obtaining a noise measurement acquired by a seismic sensor while in tow; and
based on the noise measurement, determining compensation for at least of an alignment of the sensor and a calibration of the sensor.

2. The method of claim 1, wherein the act of determining comprises:
determining a factor indicative of an alignment of the sensor relative to a streamer cable.

3. The method of claim 1, wherein the act of determining comprises:
determining a factor indicative of a sensitivity of the sensor relative to a sensitivity of other sensors.

4. The method of claim 1, wherein the act of obtaining the noise measurement comprises:
obtaining a measurement that consists essentially of perturbation noise and vibration noise.

5. The method of claim 4, wherein the measurement indicative of the perturbation and vibration noise is acquired without activation of any seismic signal source.

6. The method of claim 1, wherein the act of determining comprises:
filtering the noise measurement to extract an estimate of vibration noise and an estimate of perturbation noise; and
determining the compensation factor based on the estimates.

7. The method of claim 6, wherein the act of filtering comprises:
centering the filtering based on an expected or measured profile of the vibration noise in frequency-wavenumber space.

8. A method comprising:
obtaining a particle motion data measurement that is acquired by a seismic sensor while in tow; and
processing the particle motion measurement to remove perturbation noise based on a noise measurement acquired by the sensor while in tow.

9. The method of claim 8, wherein the perturbation noise comprises a noise associated with an alignment of the sensor with a streamer.

10. The method of claim 8, wherein the perturbation noise comprises an error associated with a sensitivity of the sensor relative to other sensors of a streamer.

11. The method of claim 8, wherein the noise measurement consists essentially of vibration noise and perturbation noise.

12. The method of claim 8, wherein the noise measurement is obtained during an operation in which no seismic source associated with a seismic towing system is activated.

13. A system comprising:
an interface to receive particle motion data acquired by a seismic sensor while in tow; and
a processor to process the particle motion data to remove perturbation noise based on calibration factors derived from a noise record acquired by towing the sensor without actuating a seismic source.

14. The system of claim 13, further comprising:
a vessel to tow a streamer containing the seismic sensor.

15. The system of claim 13, wherein the perturbation noise comprises a noise associated with an alignment of the sensor with a streamer.

16. The system of claim 13, wherein the perturbation noise comprises a noise associated with a sensitivity of the sensor relative to sensitivities of other seismic sensors.

17. The system of claim 13, wherein the processor is located in a streamer that contains the seismic sensor.

18. The system of claim 13, wherein the processor is located on a vessel that tows the seismic sensor.

19. The system of claim 13, wherein the seismic sensor is part of an array of towed seismic sensors, and the processor processes particle motion data acquired by the other seismic sensors of the array to remove perturbation noise.

20. An article comprising a computer readable storage medium storing instructions that when accessed by a processor-based system cause the processor system to:
receive particle motion data acquired by a seismic sensor while in tow; and
process the particle motion data to remove perturbation noise based on previously-recorded noise data that was acquired by the seismic sensor while in tow.

21. The article of claim 20, the storage medium storing instructions that when executed by the processor-based system cause the processor-based system to remove vibration noise from the particle motion data subsequent to the removal of the perturbation noise.

22. The article of claim 20, wherein the perturbation error comprises an error associated with an alignment of the sensor with a streamer.

23. The article of claim 20, wherein the perturbation error comprises an error associated with a sensitivity of the sensor relative to sensitivities of other seismic sensors.

24. The article of claim 20, wherein the previously-recorded noise consists essentially of perturbation noise and vibration noise.
